(19) United States
(12) Patent Application Publication
(10) Pub. No.: US 2009/0049799 A1
(43) Pub. Date: Feb. 26, 2009

(54) Vertical Packager with a Laser Marking Mechanism for Marking Crossway Placed Tear or Pre Cut Lines on Said Packages

(76) Inventor: Jose Maria Pastrana Rojas, Barcelona (ES)

Correspondence Address: Ralph A. Dowell of DOWELL & DOWELL P.C., 2111 Eisenhower Ave, Suite 406, Alexandria, VA, 22314, US

(21) Appl. No.: 12/083,439

(22) PCT Filed: Nov. 1, 2006
(86) PCT No.: PCT/EP2006/010494

§ 371 Date: Apr. 11, 2008

(30) Foreign Application Priority Data
Nov. 11, 2005 (ES) U 200502472

(51) Int. Cl. B23K 26/16; B65B 61/02; B23K 26/08; B23K 26/40; B29C 65/00

(52) U.S. Cl. 53/133.6; 53/576; 53/133.3; 219/121.69; 219/121.82

(57) ABSTRACT

This vertical packager comprises a packing sheet (2) marking mechanism (3), along the path of said packing sheet (2) from the reel (21) towards the cutting, filling, and package sealing sections (11). Said mechanism (3) includes a laser beam generator that upon application to the packing sheet (2) creates a tear line (9) of varying adjustable shapes and depths and systems for focussing of the laser beam onto the packing sheet (2), a housing mounted on movable guide sections of the focussing system, a protective casing, ventilation apparatus for the removal of smoke created and a control system for movement of the housing and for the operation of the laser beam generator.

### OBJECT OF THE INVENTION

The present invention refers to a vertical packager of the type used for the formation, filling, and closing of packages, the above mentioned packages being made from a sheet of heat sealant material.

### BACKGROUND OF THE INVENTION

Vertical packagers are used in the manufacture and filling of packages with many products. The above mentioned packages or bags consist of a sheet that once shaped and heated lengthways adopts a tubular form, thus closing the ends of the package, when filled, also by heat sealing.

This sheet is comprised of a multilayered material which includes an interior layer of a heat sealant material, for example polyethylene, a second layer of aluminium that acts as a barrier to light, and one or more exterior support layers, such as polyester or a similar material that includes the exterior impression and sometimes a protective layer against external rubbing.

The aforementioned packagers are generally comprised of a sheet feeder for the heat sealant sheets, proceeding from a reel and from which the packages will be formed, a package moulding set, heating devices for the lengthways closure of the packages, feeders of the product to be packaged and transverse heat sealers capable of cutting and the final sealing and separation of the finished packages.

The opening of the packages is done by partially or completely tearing or cutting, either by means of the use of a tool, such as a pair of scissors or a knife, or by hand. As the material is very resistant, the package sheets indicate certain areas for opening shown as a pre-cut or tear line which weakens it and facilitates opening by hand, thereby making cutting utensils unnecessary.

This tear line is placed at one end of the packages so that the product can be kept inside once the package has been opened. Nevertheless, the above mentioned opening may commonly fail due to an irregular cut, therefore various techniques exist to make the tear line with different results.

In some cases sheet reels are used which have score or tear lines pre-placed at regular intervals, meaning that the reel is ready for use once placed inside the packager, and when the position of the sheet has been adjusted, the packages are formed. If bags without either a score line or tear line are needed, it is necessary to replace the reel in use with another reel of packaging sheet without score, tear or pre-cut lines, with the consequent expense in materials, operating time and the duplication of stocks of sheet reels.

The existence of the tear lines and the pre-cut lines in the sheet means that the price of the sheets is higher than if they do not have them. These lines can be produced in the factory mechanically or by means of a laser beam, which when applied to the sheet cuts the outer layers of plastic up to the layer of aluminium, weakening the tear line area. The laser system is more precise and easier to adjust, however this system has the disadvantage of being more expensive and that the packaging machine may easily cause tears or cuts to the material along the score or tear lines due to the high amount of tension on the sheet produced between the reel and the cutting, filling and sealing sections.

This breakage or tearing risk is due to the form of the packager itself which has a vertical structure that, at the rear, has a support for the attachment of the packaging sheet reel and which is raised by a series of rollers to the top and front of the machine, then lowered to the front to the straightening, lengthways sealing, filling, crossways closure and cutting of the packages.

An additional problem of the pre-scored sheet reels is that the cut lines are all of the same shape and dept all through the reel, which can mean that the resistance of the pre-scored sheet is inadequate for the packaging of varying types of products.

### DESCRIPTION OF THE INVENTION

The packager of this invention presents technical qualities which optimise the production of packages, reducing costs and obtaining a substantial improvement in the quality and flexibility of packing. This is done by means of a mechanism which permits the marking of the score or pre-cut line to be done within the machine itself obtaining notable functional and economic advantages.

In accordance with the invention, the packaging machine includes a mechanism for optional pre-marking of the tear lines on the outer surface of the sheet designed to form the packages, the aforementioned mechanism being situated crossways in an area of the sheet path or circuit located between the feed reel of continuous sheet and the shaping, sealing, filling and package closing sections.

The mechanism incorporated in the vertical packager generates a laser beam which moves lengthways and, when applied to the packaging sheet, scores a mark or impression on the outer surface of said sheet conforming to the tear or pre cut line of the package. Given the weight of the laser generator, said generator is situated on one side of the packager and is connected to other focussing and centring parts of the beam which can be moved over the packaging sheet as it passes through the packager to create a crossways mark which highlights the tear line or pre cut line along the whole width of the sheet.

Some parts of the focussing and centring mechanism are connected to a housing mounted on motorised, crossways moving guide rails to enable the laser to be applied across the whole width of the packaging sheet.

The actual laser generator can be mounted on the housing, but to minimise inertia and slippage the elements mounted on the housing are reduced to the aforementioned focussing and centring mechanisms.

All of these elements are to be found in a casing for the safekeeping of at least the laser generator and the movable elements mounted on the crossways guide sections. In the lower part of the protective casing, there is a small crossways window or slot through which the laser beam is projected towards the sheet.

The casing also has an outlet or opening to which suction and ventilation apparatus are connected for the removal of the gases and smoke produced when marking the sheet with the laser.

The use of a control system for the movement of the housing and of the laser generator has been allowed for, operatively apt for connection, disconnection and/or for regulating the application and intensity of the laser beam so as to make the marks for the tear lines or pre cut lines. In this way, a reel of packaging sheet without tear lines or pre cut lines can be placed in the packager, and the packager can produce packages without tear line or with different types of tear lines depending on the characteristics and needs of the package or product to be packaged, which results in enhanced versatility in the fabrication process and a reduction in costs. The aforementioned control system allows the tear lines or pre cut lines to have, if necessary, various settings (continuous lines, broken lines, dots, broken lines-dots, etc) and different depths to adapt to the conditions for the sheet and the final package.

The application of the laser on the packaging sheet is synchronised to the forward sheet moving mechanism, marking the sheet crossways while the sheet has stopped and the packager undertakes the filling, sealing and cutting of the packages.

In this way, slanting movements at speed of the housing with a crossways component and with a lengthways component equal to the speed of the advance of the sheet can be avoided and the sheet can be marked with a simple movement of the laser carrier housing across the sheet.

The mechanism can incorporate spot detection or impression detection devices for the packaging sheet which highlight the lengthways starting point of each package for the correct positioning of the tear line or pre cut line.

### DESCRIPTION OF THE FIGURES

To complement the description being undertaken and with the objective of facilitating understanding of the characteristics of the invention, the present description is accompanied by a set of drawings with the purpose of illustrating but not limiting, in which the following has been represented:

FIG. 1 shows a rear view of an example of use of the vertical packager of the invention, where the side supports have been sectioned and the planned mechanism for the marking of the tear lines or pre cut lines onto the heat sealant sheet is observed.

FIG. 2 shows a sectioned high rear view of the marking mechanism showing the elements inside the protective casing.

FIG. 3 shows a block diagram of the functioning of the incorporated marking mechanism.

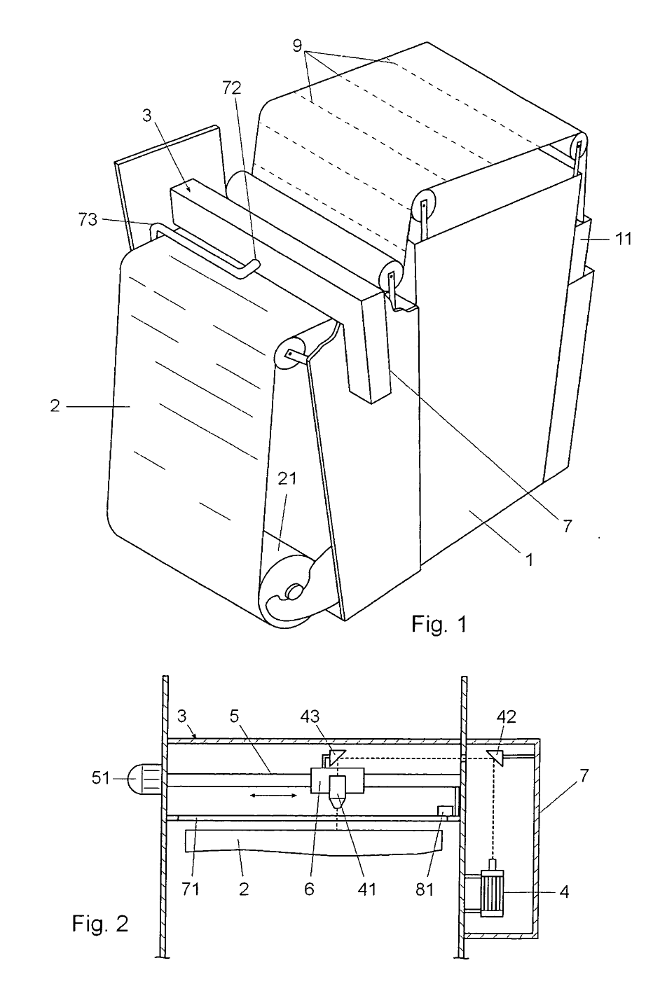

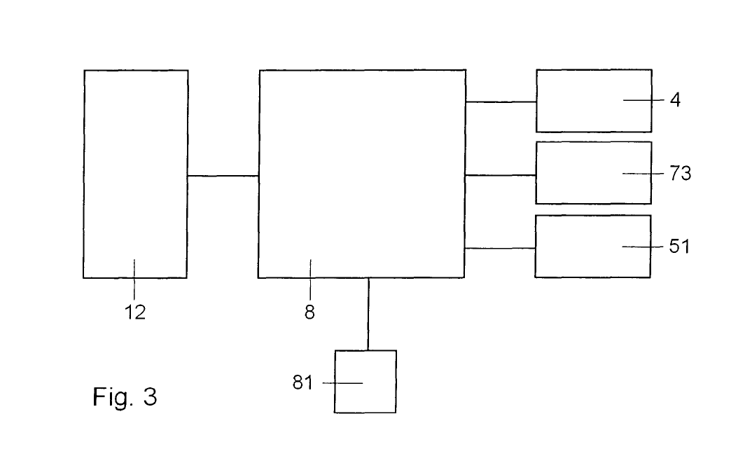

PREFERRED USAGE OF THE INVENTION

The vertical packager (1) shown in the figures is of those used in the making of packages from a multilayer packaging sheet (2). The aforementioned packaging machine (1) comprises a support at the back for the positioning of a feed reel (21) of a continuous heat sealant laminate sheet (2) from which the packages are made. The sheet (2) is fed along rollers from the reel (21) to shaping, lengthways sealing, filling and closing areas (11) situated at the front of the packager (1).

The packager comprises a laser marking mechanism (3) placed crossways above an area which the sheet passes through (2) and comprises: a laser generator (4) placed on one of the side supports; crossways guide sections (5) for movement of a housing (6); mechanisms for focussing and centring of the laser over the sheet (2) comprised of a fixed optic lens (42) which positions the laser beam from the generator (4) in a direction parallel to the guide sections (5) and by a moving optic lens (43) linked to a head (41) mounted on a housing (6), for focussing and centring of the laser beam on the sheet (2). The mechanism (3) comprises a motor (51) to move the housing (6) along the guide sections (5) i.e. in a crossways direction with respect to the sheet (2).

The mechanism (3) comprises a protective casing (7) which is elongated the full width of the packaging sheet (2) and includes a side storage area where the laser generator (4) is situated. The aforementioned casing (7) has at the bottom a small window (71) or slot through which the laser beam is applied via the head (41) onto the packaging sheet (2) and an opening (72) on one side with suction and ventilating apparatus (73) attached to ventilate the gases and smoke produced by application of the laser onto the packaging sheet (2).

The packager comprises a control system (8) of the marking mechanism, said control system (8) being connected to the packaging machine's (1) management system (12) to determine when the sheet stop (2) and to apply the laser beam. This control system (8) is linked to other detection methods (81) spot detection or impressions on the packing sheet (2) which mark the start of each printed package and allow the centring and movement of the tear line (9) to be made. The control system (8) is linked to the laser beam generator (4) to connect, disconnect or to vary its intensity; with the motor (51) used to move the housing (6); and with the ventilation apparatus (73) to ventilate the gases and smoke from inside the casing (7).

Having sufficiently described the nature of the invention, as well as an example of preferred usage procedure, notice is given that the materials, shape, size and disposition of the described elements will be able to be modified, only when it does not suppose an alteration of the essential characteristics of the invention claimed hereafter.

1. Vertical packager, of the type which comprises a support for a reel (21 ) of continuous multilayer packaging sheet (2), a circuit through which said sheet (2) passes and means (11) of cutting, filling and sealing of the packages, characterised in that it comprises a laser marking mechanism (3) for marking the said packaging sheets (2) placed crossways at an area which the said sheet (2) passes through operatively apt for making of tear lines or pre cut lines crossways on said sheet (2); and because said mechanism (3) comprises: a laser generator (4); focussing and centring systems to position the laser beam onto the packaging sheet (2) to create a crossways tear line (9) or pre cut line on the whole or part of said packaging sheet; crossways guide sections (5) equipped with a motorised crossways movable housing (6) with at least some parts of the focussing and centring mechanisms to allow the application of the laser beam onto the whole width of the packaging sheet (2) a control system (8) for moving the housing (6) and for use of the laser beam generator (4) operatively apt for activating or deactivating and/or adjusting the application and intensity of the laser beam for the purpose of creating tear lines (9) or pre cut lines of varying shapes and depths in the sheet (2).

2. Packager, according to claim 1, characterised by the fact that the laser generator (4) is situated on one side of the casing; and in that the focussing and centring systems comprises at least a movable optic lens (43) mounted on a movable housing (6).

3. Packager, according to claim 2, characterised by the fact that the focussing and centring systems comprise a fixed optic lens (42) for directing the laser beam from the generator (4) in a crossways direction parallel to the guide sections (5) and towards the lens (43) linked to the movable housing (6).

4. Packager, according to claim 1, characterised by the fact that the mechanism (3) comprises a protective casing (7) with a small window (71) at the bottom for application of the laser beam onto the whole width of the sheet (2) during the crossways movement of the housing (6).

5. Packager according to claim 1, characterised by the fact that the casing (7) has a window (71) with ventilation apparatus (73) connected to ventilate the gas and smoke created whilst applying the laser to the sheet (2).

6. Packager, according to claim 1, characterised by the fact that it comprises spot detection (81) or packaging sheet impression detection (2) systems which denote the lengthways starting point for each package for correct positioning of the tear line (9) or pre cut line.
